(19) United States
(12) Patent Application Publication
(10) Pub. No.: US 2024/0363263 A1
(43) Pub. Date: Oct. 31, 2024

(54) WIRE HARNESS AND MANUFACTURING METHOD OF WIRE HARNESS

(71) Applicant: YAZAKI CORPORATION, Tokyo (JP)

(72) Inventors: Takashi Ookawa, Makinohara-shi (JP); Yuuki Koike, Makinohara-shi (JP); Harutake Satoh, Susono-shi (JP)

(21) Appl. No.: 18/628,682

(22) Filed: Apr. 6, 2024

(30) Foreign Application Priority Data
Apr. 25, 2023 (JP) 2023-071490

(51) Int. Cl. H01B 7/00; H01B 13/012; H01B 13/06

(52) U.S. Cl. CPC H01B 7/0045; H01B 13/01209; H01B 13/06

(57) ABSTRACT

A harness component that includes an electric wire group including a plurality of electric wires and a pair of sheet-shaped insulating exterior members sandwiching and housing a protection target region of the electric wire group therein is provided. The harness component includes joint portions in contact with each other between the pair of exterior members, and a weld having two free ends where the joint portions are welded to each other along an axial direction of the protection target region between the joint portions in contact with each other.

### CROSS-REFERENCE TO RELATED APPLICATION(S)

The present application claims priority to and incorporates by reference the entire contents of Japanese Patent Application No. 2023-071490 filed in Japan on Apr. 25, 2023.

### BACKGROUND OF THE INVENTION

### 1. Field of the Invention

The present invention relates to a wire harness and a manufacturing method of a wire harness.

### 2. Description of the Related Art

In a wire harness, an electric wire group is protected by an exterior member. As the exterior member, for example, a tubular member such as a sheet wound around the electric wire group or a corrugated tube housing the electric wire group is used. The sheet is fixed to the electric wire group using an adhesive member such as a double-sided tape provided inside the winding (for example, Japanese Patent Application Laid-open No. H7-105756 below). Further, the tubular member is fixed by winding an adhesive tape around both ends thereof and the electric wire group.

Meanwhile, in the conventional wire harness, the adhesive member or adhesive tape for fixing is also required as a component in addition to the exterior member. Further, in the conventional wire harness, a work process of winding the adhesive tape for fixing is also required when the tubular member is used for the exterior member. Thus, in the conventional wire harness, the adhesive member or adhesive tape for fixing cause an increase in cost.

### SUMMARY OF THE INVENTION

Therefore, an object of the present invention is to provide a wire harness and a manufacturing method of a wire harness capable of reducing cost.

A wire harness according to one aspect of the present invention includes a harness component that includes an electric wire group including a plurality of electric wires, and a pair of sheet-shaped insulating exterior members sandwiching a protection target region of the electric wire group and housing the protection target region inside, wherein the harness component includes joint portions in contact with each other between the pair of exterior members, and a weld having two free ends where the joint portions are welded to each other along an axial direction of the protection target region between the joint portions in contact with each other.

A wire harness according to another aspect of the present invention includes a harness component that includes an electric wire group including a plurality of electric wires, and a sheet-shaped insulating exterior member that is folded and houses a protection target region of the electric wire group inside a fold, wherein the harness component includes joint portions in contact with each other at tips of the fold of the exterior member, and a weld having two free ends where the joint portions are welded to each other along an axial direction of the protection target region between the joint portions in contact with each other.

A wire harness according to still another aspect of the present invention includes a plurality of harness components each of which includes an electric wire group including a plurality of electric wires and a sheet-shaped insulating exterior member housing a protection target region of the electric wire group inside, wherein at least one first harness component and at least one second harness component are provided as the harness components, the first harness component including a first electric wire group as the electric wire group and a pair of first exterior members that sandwich and house a protection target region of the first electric wire group inside and serve as the exterior member, the second harness component including a second electric wire group as the electric wire group and a second exterior member that is folded, houses a protection target region of the second electric wire group inside a fold, and serves as the exterior member, the first harness component includes joint portions in contact with each other between the pair of the first exterior members, and a weld having two free ends where the joint portions are welded to each other along an axial direction of the protection target region of the first electric wire group between the joint portions in contact with each other, the second harness component includes joint portions in contact with each other at tips of the fold of the second exterior member, and a weld having two free ends where the joint portions are welded to each other along an axial direction of the protection target region of the second electric wire group between the joint portions in contact with each other, and the plurality of harness components are integrated by welding the joint portions between the exterior members of the plurality of harness components.

A manufacturing method of a wire harness, according to still another aspect of the present invention includes a first installation process of placing one sheet-shaped insulating exterior member on an installation surface of a first mold; a second installation process of placing a protection target region of an electric wire group including a plurality of electric wires on the one exterior member; a third installation process of placing another sheet-shaped insulating exterior member on the one exterior member and the protection target region and sandwiching the protection target region between the one exterior member and the another exterior member; a fourth installation process of sandwiching first end portion sides and second end portion sides, viewed from the protection target region, in the one exterior member and the another exterior member between the first mold and a second mold; and a welding process of welding the first end portion sides and the second end portion sides in the one exterior member and the another exterior member along an axial direction of the protection target region.

A manufacturing method of a wire harness according to still another aspect of the present invention includes a first installation process of bending and placing a sheet-shaped insulating exterior member into a V-shaped or U-shaped bent shape along a shape of a V-shape or U-shaped trench in the trench provided in a jig; a second installation process of installing a protection target region of an electric wire group including a plurality of electric wires in the exterior member having the bent shape; a third installation process of sandwiching end portions at tips of a fold with the protection target region as an axis in the exterior member between a first mold and a second mold; and a welding process of welding the end portions of the exterior member to each other along an axial direction of the protection target region.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view illustrating a wire harness of an embodiment;

FIG. 2 is a plan view illustrating a modification of the wire harness of the embodiment;

FIG. 3 is an exploded perspective view illustrating the wire harness of the embodiment;

FIG. 4 is an exploded perspective view illustrating the modification of the wire harness of the embodiment;

FIG. 5 is an explanatory view for describing a manufacturing process of the wire harness of the embodiment;

FIG. 6 is a plan view for describing handling of an excess portion of the wire harness of the embodiment;

FIG. 7 is a plan view for describing handling of an excess portion of the modification of the wire harness of the embodiment;

FIG. 8 is a plan view for describing an auxiliary weld of the modification of the wire harness of the embodiment;

FIG. 9 is a plan view illustrating the wire harness of the embodiment provided with a clamp;

FIG. 10 is a plan view illustrating a modification of the wire harness of the embodiment provided with the clamp;

FIG. 11 is a perspective view for describing the clamp;

FIG. 12 is a plan view illustrating a modification of the wire harness of the embodiment;

FIG. 13 is a plan view illustrating a modification of the wire harness of the embodiment;

FIG. 14 is a plan view illustrating a modification of the wire harness of the embodiment;

FIG. 15 is a plan view for describing a through-hole used in a manufacturing process of a modification of the wire harness of the embodiment;

FIG. 16 is a plan view for describing a through-hole used in a manufacturing process of a modification of the wire harness of the embodiment;

FIG. 17 is a plan view for describing another use mode of the exterior member;

FIG. 18 is a perspective view illustrating a wire harness of a first modified example;

FIG. 19 is an explanatory view for describing a manufacturing process of the wire harness of the first modified example;

FIG. 20 is an explanatory view for describing the manufacturing process of the wire harness of the first modified example;

FIG. 21 is a plan view illustrating a wire harness of a second modified example;

FIG. 22 is a plan view illustrating a modification of the wire harness of the second modified example;

FIG. 23 is an explanatory view for describing a manufacturing process of the wire harness of the second modified example;

FIG. 24 is an explanatory view for describing the manufacturing process of the wire harness of the second modified example;

FIG. 25 is an explanatory view for describing the manufacturing process of the wire harness of the second modified example;

FIG. 26 is a plan view for describing an auxiliary weld of a modification of the wire harness of the second modified example;

FIG. 27 is a plan view illustrating the wire harness of the second modified example provided with the clamp;

FIG. 28 is a plan view illustrating a modification of the wire harness of the second modified example provided with the clamp;

FIG. 29 is a plan view illustrating a wire harness of a third modified example;

FIG. 30 is an explanatory view for describing a manufacturing process of the wire harness of the third modified example;

FIG. 31 is an explanatory view for describing the manufacturing process of the wire harness of the third modified example;

FIG. 32 is an explanatory view for describing the manufacturing process of the wire harness of the third modified example;

FIG. 33 is a plan view illustrating a wire harness of a fourth modified example separated for each harness component; and

FIG. 34 is a plan view illustrating the wire harness of the fourth modified example.

### DETAILED DESCRIPTION OF THE PREFERRED EMBODIMENTS

Hereinafter, embodiments of a wire harness and a manufacturing method of a wire harness according to the present invention will be described in detail with reference to the drawings. Incidentally, the invention is not limited by the embodiments.

### EMBODIMENT

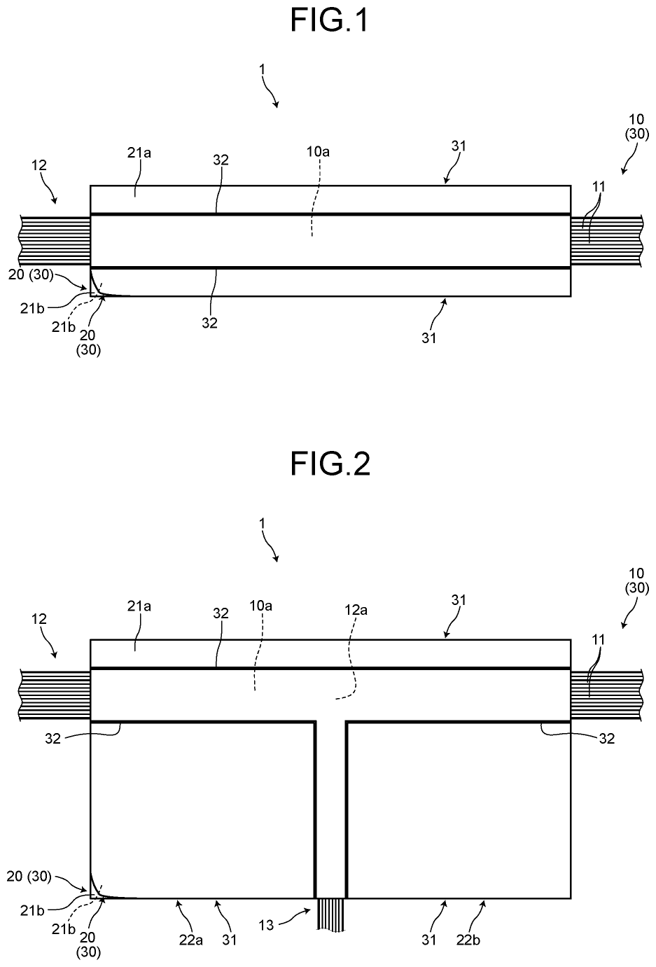

One of the embodiments of the wire harness according to the present invention will be described with reference to FIGS. 1 to 16.

Reference numeral 1 in FIGS. 1 to 4 denotes a wire harness of the present embodiment.

The wire harness 1 is provided with a harness component 30 that includes an electric wire group 10 including a plurality of electric wires 11, and a pair of sheet-shaped insulating exterior members 20 that sandwich and house a protection target region 10a of the electric wire group 10 (FIGS. 1 to 4). The harness component 30 includes joint portions 31 which come into contact with each other between the pair of exterior members 20 and welds 32 having two free ends where the joint portions 31 are welded along an axial direction of the protection target region 10a between the joint portions 31 in contact with each other (FIGS. 1 to 4). In order to weld the exterior members 20 to each other in the harness component 30, the exterior members 20 are molded using an insulating raw material that enables the welding. The exterior member 20 exemplified here is molded using vinyl chloride, polyvinyl chloride, polyamide, or the like as the raw material, and is welded using a well-known welding technique such as high-frequency welding or ultrasonic welding. The pair of exterior members 20 may be mutually different members, or may be the same member.

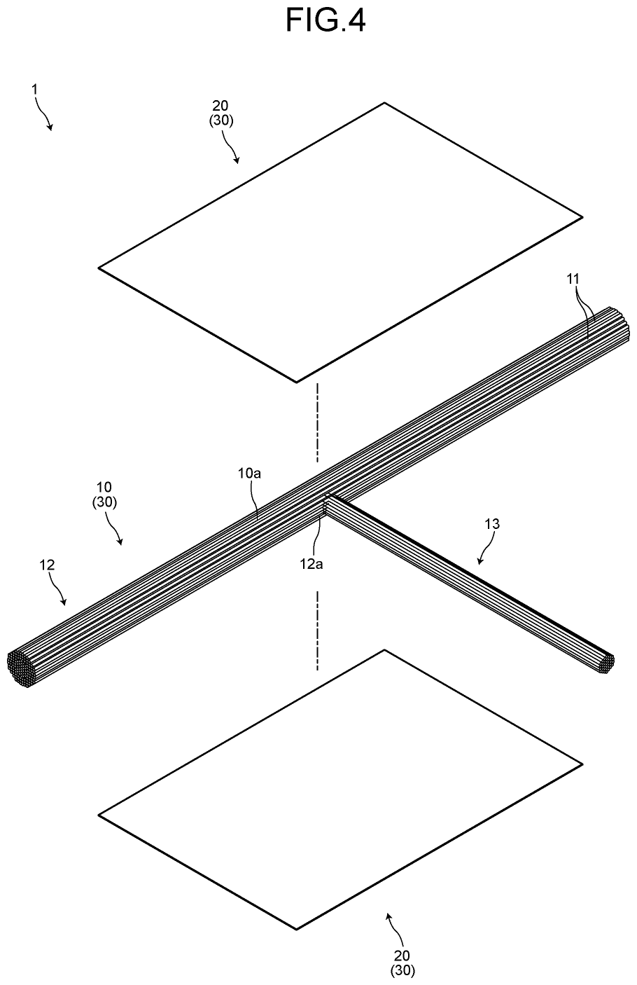

In the electric wire group 10, the plurality of electric wires 11 are bundled together (FIGS. 1 to 4). The electric wire group 10 includes a trunk line 12 and a branch electric wire 13 branching from a branch portion 12a of the trunk line 12 (FIGS. 2 and 4).

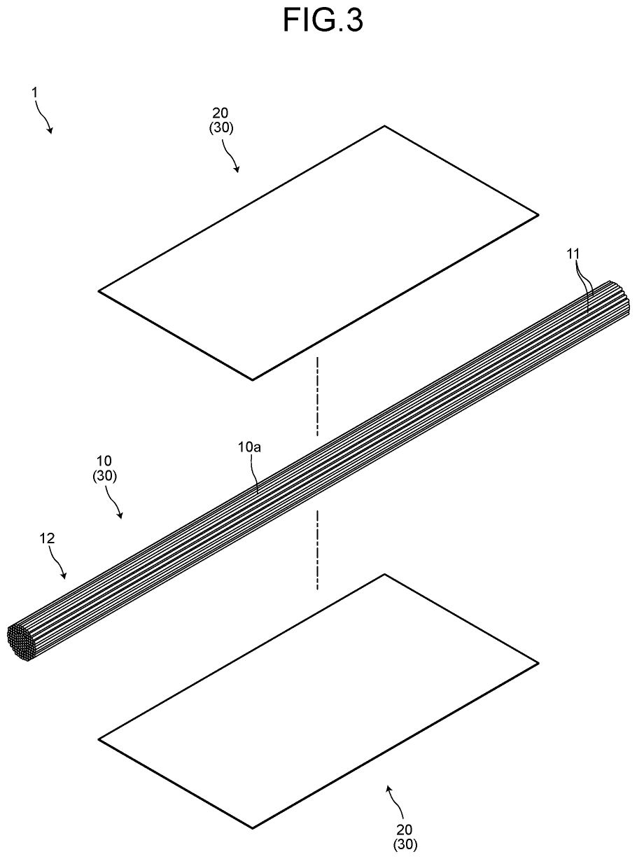

In the harness component 30 illustrated here, a part of the trunk line 12 is set as the protection target region 10a, and the part of the trunk line 12 is sandwiched between the pair of exterior members 20 (FIGS. 1 and 3). Further, at a place different from the protection target region 10a, a part of the trunk line 12 including the branch portion 12a and the branch electric wire 13 are set as the protection target region 10a, and the periphery of the electric wire group 10 including the branch portion 12a is sandwiched between the pair of exterior members 20 (FIGS. 2 and 4). In the harness component 30, first end portion sides 21a coming into contact with each other and second end portion sides 21b coming into contact with each other with the former protection target region 10a (a part of the trunk line 12) in the pair of exterior members 20 as a boundary are respectively set as the joint portions 31, and the weld 32 is provided between the first end portion sides 21a and between the second end portion sides 21b which are the joint portions 31 (FIG. 1). Further, in the harness component 30, in the latter protection target region 10a, the first end portion sides 21a coming into contact with each other with the trunk line 12 as a boundary in the pair of exterior members 20, and intermediate portions 22a and 22b located between the trunk line 12 and the branch electric wire 13 on the second end portion sides 21b coming into contact with each other with the trunk line 12 as a boundary in the pair of exterior members 20 are set as the joint portions 31, respectively, and the weld 32 is provided between the intermediate portions 22a and between the intermediate portions 22b which are the joint portions 31 (FIG. 2). In the latter protection target region 10a, one branch electric wire 13 is branched from the branch portion 12a of the trunk line 12, and the intermediate portions 22a in contact with each other and the intermediate portions 22b in contact with each other are formed at two locations in the pair of exterior members 20.

A shape of the exterior member 20 is determined in accordance with a shape of the protection target region 10a. Here, the exterior member 20 having a rectangular sheet shape is used (FIGS. 1 to 4). Thus, each of the first end portion sides 21a and the second end portion sides 21b as the joint portions 31 are formed to be rectangular by setting the axis of the former protection target region 10a (a part of the trunk line 12) along opposite sides of the pair of exterior members 20 on one side (FIG. 1). In the former protection target region 10a, the linear welds 32 extending in the axial direction of the protection target region 10a are formed between the first end portion sides 21a as the joint portion 31 and between the second end portion sides 21b as the joint portion 31, respectively. Each of the welds 32 is disposed close to the protection target region 10a (a part of the trunk line 12). Further, in the latter protection target region 10a (the periphery of the electric wire group 10 including the branch portion 12a), since the trunk line 12 and the branch electric wire 13 are orthogonal to each other, the first end portion sides 21a as the joint portion 31 and the intermediate portions 22a and 22b at the two locations as the joint portions 31 on the second end portion sides 21b are formed to be rectangular by setting the axis of the trunk line 12 along opposite sides of the pair of exterior members 20 on one side (FIG. 2). In the latter protection target region 10a, the linear weld 32 extending in an axial direction of the trunk line 12 is formed between the first end portion sides 21a, and the L-shaped welds 32 each extending from the branch portion 12a in the axial direction of the trunk line 12 and an axial direction of the branch electric wire 13 are formed between the intermediate portions 22a and between the intermediate portions 22b, respectively. Each of the welds 32 is disposed close to the trunk line 12 and the branch electric wire 13.

The wire harness 1 is assembled by, for example, the following manufacturing method. Here, an example will be given regarding the former protection target region 10a (a part of the trunk line 12).

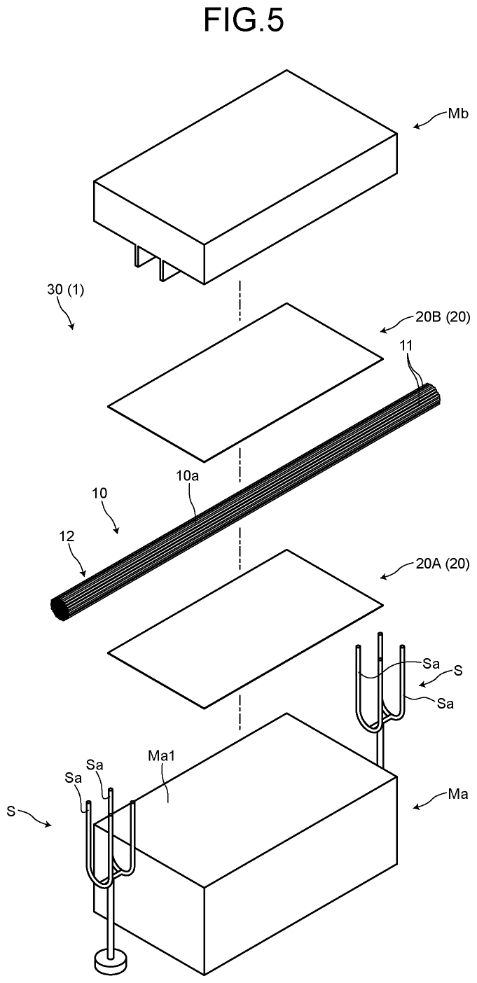

This manufacturing method includes a first installation process of placing one of the pair of exterior members 20 (hereinafter referred to as “one exterior member 20A”) on an installation surface Ma1 of a first mold Ma (FIG. 5). For example, the first mold Ma is installed on a so-called jig plate or the like configured to assemble the wire harness 1.

This manufacturing method includes a second installation process of placing the protection target region 10a of the electric wire group 10 on the one exterior member 20A on the first mold Ma (FIG. 5). In the second installation process, both end sides of the protection target region 10a in the electric wire group 10 are respectively supported by support members S on the jig plate. The support member S is provided with support portions Sa which allow the electric wire group 10 to pass therethrough while supporting the electric wire group 10 in an inner space thereof. The support portion Sa includes two support pins disposed to face each other with an interval therebetween, and a bottom connecting end portions of the two support pins on one side. In the support portion Sa, the electric wire group 10 is inserted into the inner space formed by the two support pins and the bottom from between end portions of the two support pins on the other side. Then, the electric wire group 10 is supported by being placed on the bottom in the inner space of the support portion Sa, and the electric wire group 10 is supported from both sides by the two support pins. For example, the support portion Sa is formed in a support shape such as a U shape or a V shape having the two support pins and the bottom. In the support member S, the support portion Sa is provided at least at one location. In the support member S in this example, the support portion Sa formed in a U shape is provided at two locations.

This manufacturing method includes a third installation process of placing the other (hereinafter referred to as “other exterior member 20B”) of the pair of exterior members 20 on the one exterior member 20A and the protection target region 10a and sandwiching the protection target region 10a between the one exterior member 20A and the other exterior member 20B (FIG. 5).

This manufacturing method includes a fourth installation process of sandwiching the first end portion sides 21a and the second end portion sides 21b, viewed from the protection target region 10a, in the one exterior member 20A and the other exterior member 20B between the first mold Ma and a second mold Mb (FIG. 5).

This manufacturing method includes a welding process of welding the first end portion sides 21a and the second end portion sides 21b of the one exterior member 20A and the other exterior member 20B along the axial direction of the protection target region 10a. Here, the first mold Ma and the second mold Mb also serve as electrodes, and predetermined locations on the first end portion sides 21a and the second end portion sides 21b are heated and welded. As a result, the linear welds 32 along the former protection target region 10a (a part of the trunk line 12) are formed on the first end portion sides 21a and the second end portion sides 21b, respectively.

According to this manufacturing method, it is possible to attach the pair of exterior members 20 to the protection target region 10a of the electric wire group 10 with a minimum necessary work space on the jig plate.

Since the protection target region 10a of the electric wire group 10 is sandwiched between the pair of exterior members 20, and the joint portions 31 of the pair of exterior members 20 in contact with each other are welded in the wire harness 1 of the present embodiment as described above, the protection target region 10a can be insulated and protected by the pair of exterior members 20. Thus, the wire harness 1 does not require an adhesive member or an adhesive tape to fix an exterior member as in a conventional wire harness, so that cost reduction can be achieved. Further, the wire harness 1 does not require a work process of winding the adhesive tape, and thus, cost reduction can be achieved. For example, in the conventional wire harness, a worker manually winds the adhesive tape for fixing. Therefore, the wire harness 1 of the present embodiment has a high cost reduction effect as compared with the conventional wire harness, and further, variations in quality of the exterior member 20 attached to the protection target region 10a can be suppressed as compared with the conventional wire harness.

Further, since the wire harness 1 of the present embodiment sandwiches the protection target region 10a of the electric wire group 10 between the pair of exterior members 20, it is possible to cope with various lengths and various thicknesses of the electric wire group 10 only by changing a size of the exterior member 20.

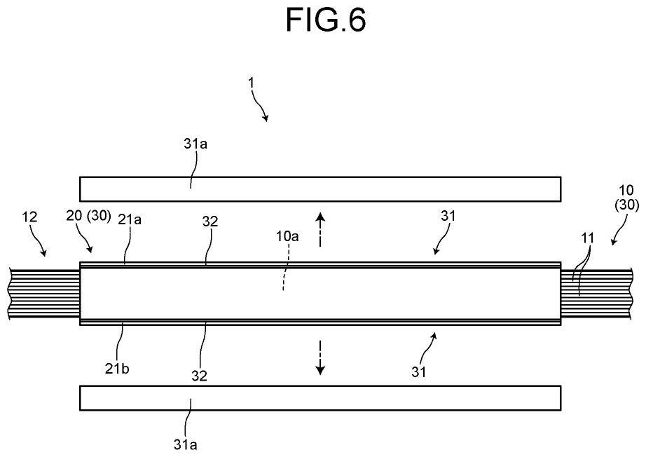

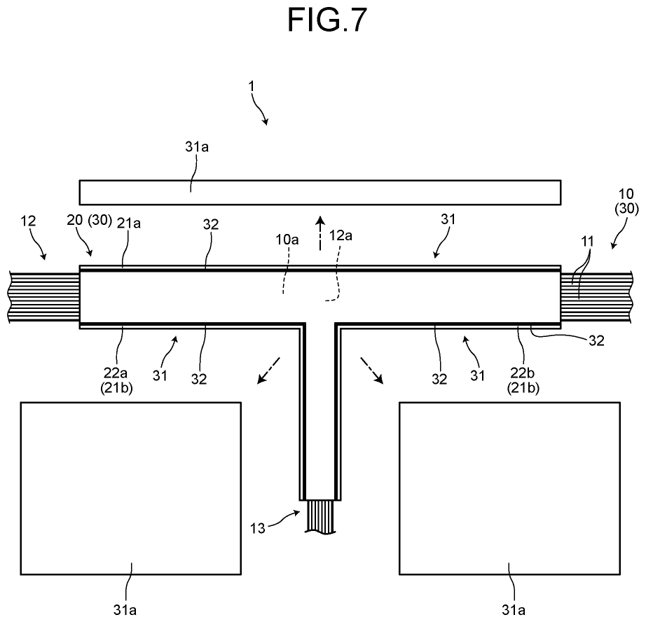

Meanwhile, since the welds 32 are formed between the respective joint portions 31 of the pair of exterior members 20 to be close to the trunk line 12 and the branch electric wire 13 in the wire harness 1 of the present embodiment, there is an excess portion 31a that is not welded between the joint portions 31 (FIGS. 6 and 7). Thus, the excess portion 31a in the harness component 30 may be cut off after welding. Further, the exterior member 20 molded into a form without the excess portion from the beginning may be used in the wire harness 1 of the present embodiment.

Furthermore, in the wire harness 1 of the present embodiment, when a part of the trunk line 12 including the branch portion 12a and the branch electric wire 13 are set as the protection target region 10a, the L-shaped welds 32 extending from the branch portion 12a in the axial direction of the trunk line 12 and the axial direction of the branch electric wire 13 are formed at the intermediate portions 22a and 22b of the pair of exterior members 20 as described above (FIG. 2). Further, the welds 32 are formed close to the trunk line 12 and the branch electric wire 13 (FIG. 2). For example, in a case where the pair of exterior members 20 is molded into a sheet shape and has flexibility in the harness component 30, there is a possibility that it is difficult to keep the shape constant between the trunk line 12 and the branch electric wire 13 because the branch electric wire 13 approaches the trunk line 12 along with deflection of the joint portion 31. In particular, when the excess portion (portion not welded between the pair of exterior members 20) 31a is cut off so as not to remain in the intermediate portions 22a and 22b of the pair of exterior members 20 in the harness component 30 (FIG. 7), the branch electric wire 13 is likely to approach the trunk line 12.

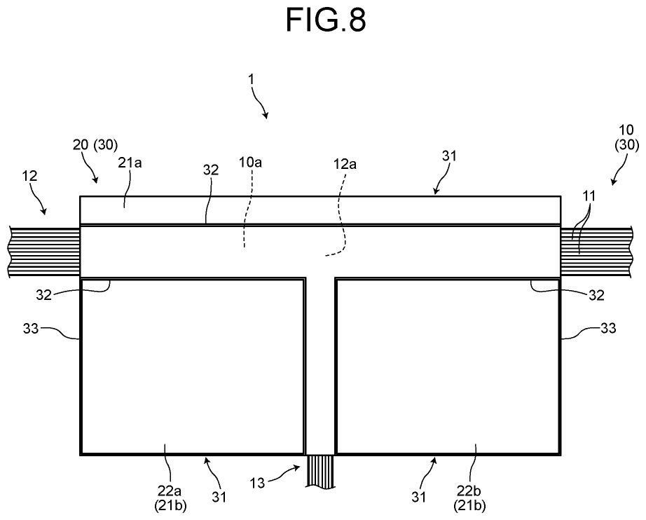

Therefore, it is desirable to provide harness component 30 with auxiliary welds 33 each of which is formed by welding the joint portions 31 between one free end and the other free end of the weld 32 between the joint portions 31 in contact with each other of the pair of exterior members 20 so as to connect the one free end and the second free (FIG. 8). For example, the auxiliary weld 33 is formed by welding outer peripheral edges of the joint portions 31 in contact with each other (each of the Intermediate portions 22a and 22b) of the pair of exterior members 20 to connect the one free end and the other free end of the weld 32. As a result, in the wire harness 1 of the present embodiment, the joint portions 31 (the intermediate portions 22a and 22b) on the first end portion sides 21a and the second end portion sides 21b of the pair of exterior members 20 can be increased in rigidity and prevented from being deflected, and thus, the shape can be kept constant between the trunk line 12 and the branch electric wire 13.

Here, the one free end and the other free end of the weld 32 are connected by the linear auxiliary weld 33 at each of the intermediate portions 22a and 22b of the pair of exterior members 20. Further, the auxiliary weld 33 may be formed by welding the entire excess portions with respect to the linear welds 32.

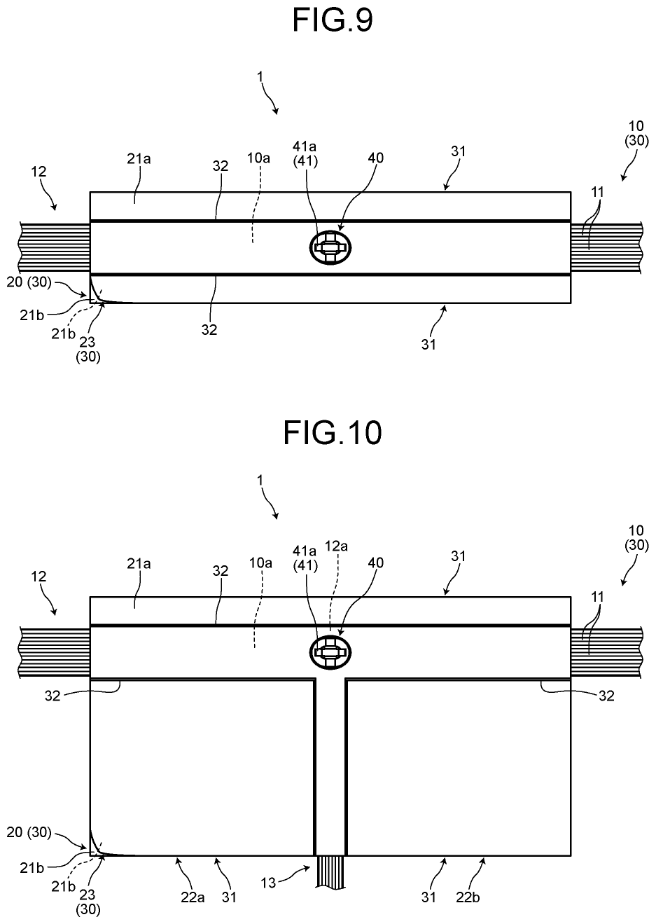

Here, the wire harness 1 of the present embodiment is routed along a structure such as a vehicle body in a vehicle, and is assembled and fixed to the structure. The structure is an object to be assembled, and the wire harness 1 includes a clamp 40 for assembling and fixing a predetermined location of the electric wire group 10 to the object to be assembled (FIGS. 9 and 10). In the wire harness 1, the clamp 40 is fixed to the predetermined location of the electric wire group 10 by an exterior member 23. Examples of the predetermined location of the electric wire group 10 include the protection target region 10a of the electric wire group 10, places provided at predetermined intervals on a routing path of the electric wire group 10, and a routing path change location such as a folding point of the electric wire group 10. Further, the exterior member 23 is a weldable sheet-shaped member similar to the exterior member 20.

For example, the clamp 40 is fixed to the protection target region 10a of the electric wire group 10 by the exterior member 23 (FIGS. 9 and 10). In the harness component 30 of FIG. 9, a part of the trunk line 12 is set as the protection target region 10a, and the clamp 40 is fixed to the protection target region 10a by the exterior member 23. Further, in the harness component 30 of FIG. 10, a part of the trunk line 12 including the branch portion 12a and the branch electric wire 13 are set as the protection target region 10a, and the clamp 40 is fixed to the protection target region 10a by the exterior member 23.

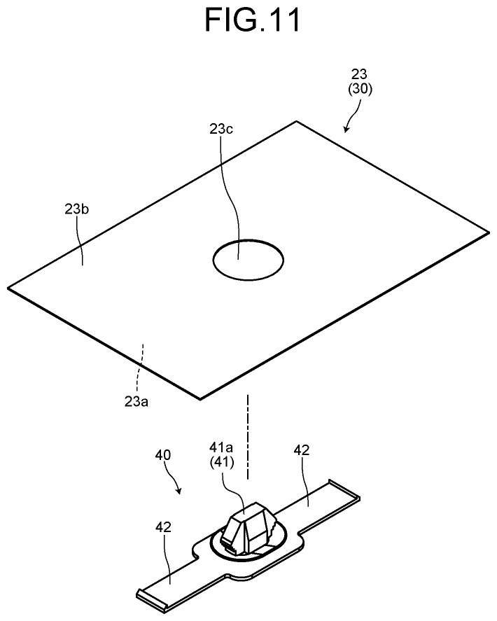

The clamp 40 includes a clamp body 41 configured to assemble the predetermined location of the electric wire group 10 to the object to be assembled, and a fixing protrusion 42 protruding from the clamp body 41 (FIG. 11).

The clamp body 41 has a locking portion 41a to be locked to the object to be assembled (FIGS. 9 to 11). The locking portion 41a is formed in, for example, an anchor shape or the like that can be inserted into a through-hole of a flat plate portion of the object to be assembled from one flat surface side and hooked and locked to the other flat surface of the flat plate portion. The fixing protrusion 42 is a region used to attach the clamp 40 to the exterior member 23. Here, the fixing protrusion 42 is provided at two locations.

In this wire harness 1, a pair of exterior members is attached to the protection target region 10a in the same manner as in the above examples. Here, the above-described exterior member 20 is used as one of the pair of exterior members, and the exterior member 23 is used as the other of the pair of exterior members (FIGS. 9 and 10). The exterior member 23 corresponds to the exterior member 20 provided with a through-hole for insertion of the clamp body 41. Therefore, the exterior member 23 has a through-hole 23c through which the clamp body 41 is inserted from a first wall surface 23a side to a second wall surface 23b side (FIG. 11). In the exterior member 23, the fixing protrusions 42 are sandwiched between the first wall surface 23a and the electric wire group 10 in a state where the clamp body 41 is inserted through the through-hole 23c. Therefore, in the wire harness 1, the joint portions 31 of the one exterior member 20 and the other exterior member 23 are welded in the state where the clamp body 41 is inserted through the through-hole 23c of the other exterior member 23, whereby the clamp 40 is fixed by the other exterior member 23 and the protection target region 10a of the electric wire group 10.

In the harness component 30 of FIG. 10, the weld 32 of the intermediate portion 22a and the weld 32 of the intermediate portion 22b are brought close to the branch electric wire 13, and the branch electric wire 13 is sandwiched between the welds 32 at the two locations, and the welds 32 at the two locations suppress relative displacement of the pair of exterior members (the one exterior member 20 and the other exterior member 23) with respect to the axial direction of the trunk line 12. Thus, relative displacement of the clamp 40 with respect to the axial direction of the trunk line 12 can be suppressed by the welds 32 at the two locations in the harness component 30. For example, in the exterior member 23 illustrated in FIG. 10, the clamp 40 is attached to the branch portion 12a by providing the through-hole 23c in a place where the branch portion 12a is present.

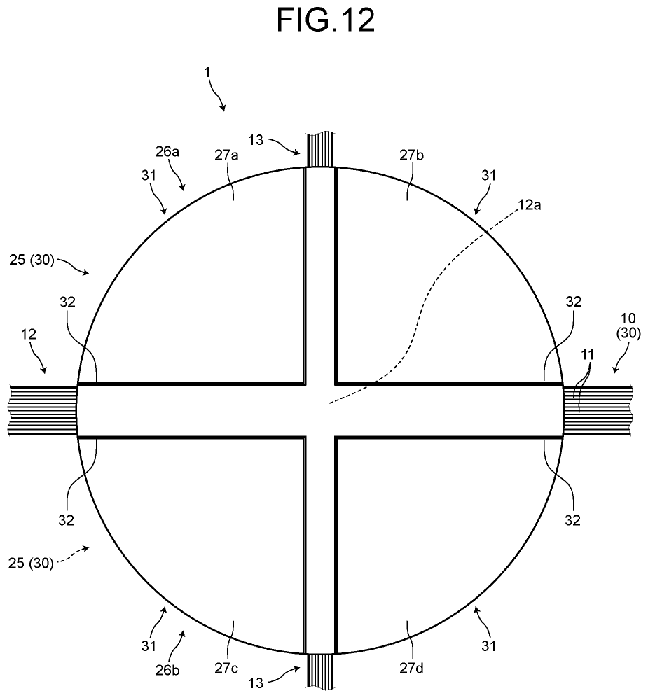

Furthermore, in the wire harness 1 of the present embodiment, the exterior member 20 and the exterior member 23 molded in rectangular sheet shapes are used since a part of the linear trunk line 12 is set as the protection target region 10a, or a T-shaped portion in the periphery of the branch portion 12a including a part of the linear trunk line 12 and one linear branch electric wire 13 is set as the protection target region 10a. However, the wire harness 1 may use a sheet-shaped exterior member having a shape other than a rectangle in accordance with a shape of the protection target region 10a. For example, if a plurality of (here, two) branch electric wires 13 are branched from the branch portion 12a of the trunk line 12, and the trunk line 12 and the plurality of branch electric wires 13 form a radial shape such as a cross with the branch portion 12a as the center in the wire harness 1, for example, a pair of exterior members 25 having a circular sheet shape with the branch portion 12a as the center may be used at such a place (FIG. 12). In the harness component 30 in this case, intermediate portions 27a and 27b located between the trunk line 12 and one branch electric wire 13 on first end portion sides 26a in contact with each other with the trunk line 12 as a boundary in the pair of exterior members 25 and intermediate portions 27c and 27d located between the trunk line 12 and the other branch electric wire 13 on second end portion sides 26b in contact with each other with the trunk line 12 as a boundary in the pair of exterior members 25 are set as the joint portions 31, respectively, and the L-shaped weld 32 having two free ends is provided in each of the joint portions 31.

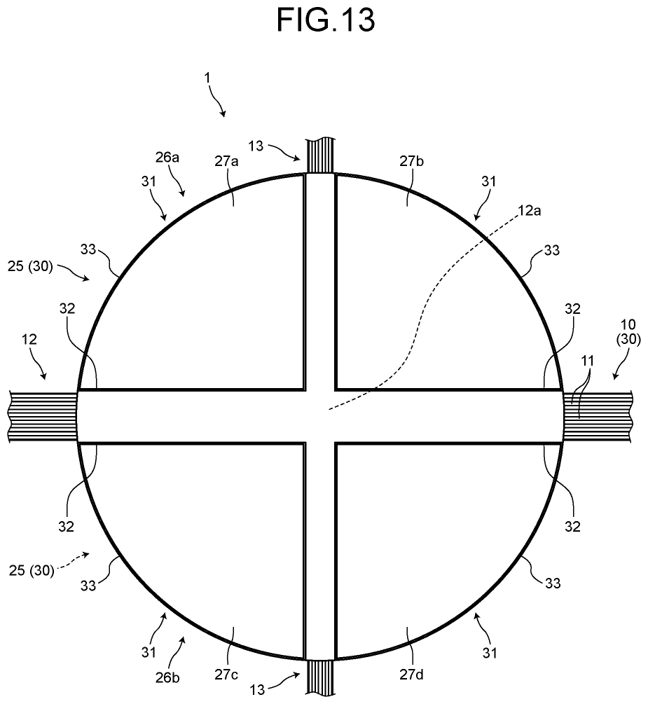

The auxiliary weld 33 described above may be provided at an outer peripheral edge of each of the intermediate portions 27a, 27b, 27c, and 27d (FIG. 13).

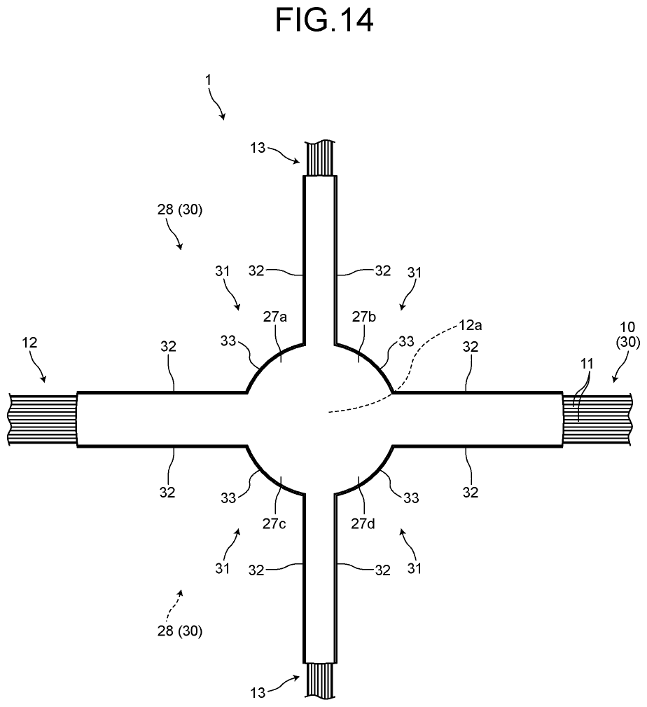

Incidentally, an outer shape of each of the intermediate portions 27a, 27b, 27c, and 27d may be made smaller in the harness component 30. For example, in this case, an exterior member 28 is applied such that a circular portion forming the small-diameter intermediate portions 27a, 27b, 27c, and 27d and a cross-shaped portion corresponding to the trunk line 12 and the two branch electric wires 13 are combined into one (FIG. 14). Then, in this case, the auxiliary welds 33 are provided at outer peripheral edges of the small-diameter intermediate portions 27a, 27b, 27c, and 27d. The auxiliary weld 33 in this case connects an end portion of the weld 32 along the trunk line 12 and an end portion of the weld 32 along the branch electric wire 13.

Further, in the wire harness 1, a through-hole similar to the above-described through-hole 23c of the exterior member 23 may be provided in any one of the pair of exterior members 25, and the clamp 40 may be fixed by the exterior member 25 provided with the through-hole and the protection target region 10a of the electric wire group 10 (not illustrated).

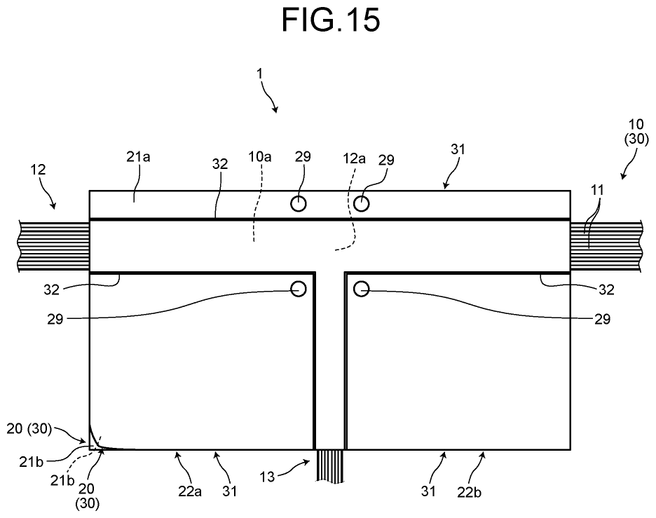

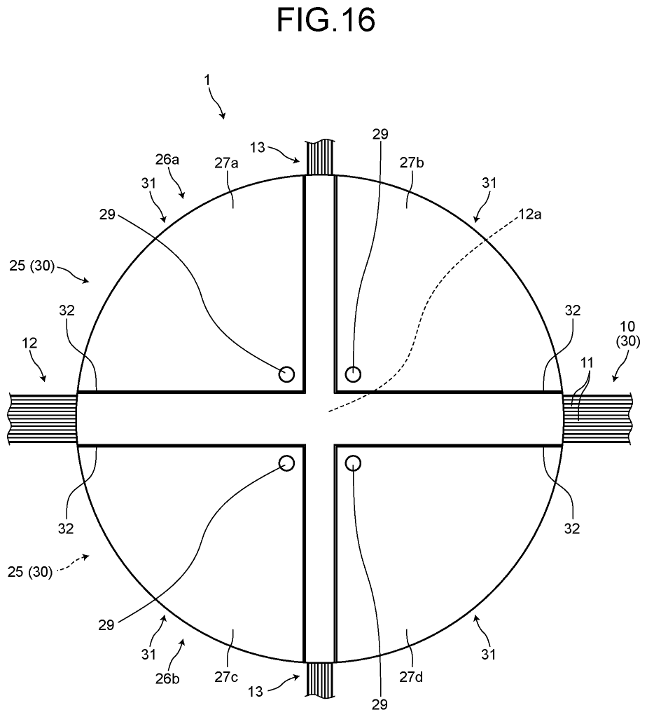

Here, the branch portion 12a is also supported by the above-described support member S, for example, in a manufacturing process of the wire harness 1 of the present embodiment. Since the branch portion 12a is covered by the exterior member 20, 23, or 25 in the wire harness 1, through-holes 28 are formed in the vicinity of the branch portion 12a in the joint portions 31 of the exterior member 20, 23, or 25 (FIGS. 15 and 16), and the support pin of the support member S can be inserted into through-holes 28 when the exterior member 20, 23, or 25 is assembled to the protection target region 10a. Here, a mode of each drawing is representatively illustrated.

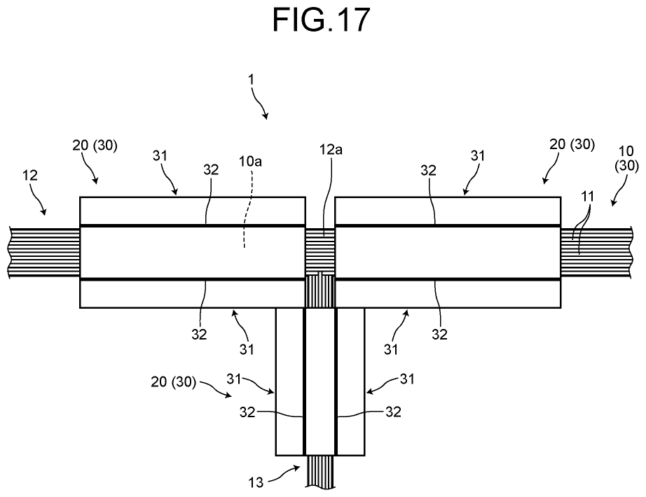

Incidentally, in the wire harness 1, for example, a pair of the exterior members 20 may be provided in front of and behind the branch portion 12a of the trunk line 12, respectively, a plurality of desired electric wires 11 may be drawn out from the branch portion 12a, and a pair of the exterior members 20 may also be provided for the plurality of electric wires 11 to create the branch electric wire 13 branched from the trunk line 12 (FIG. 17).

### First Modified Example

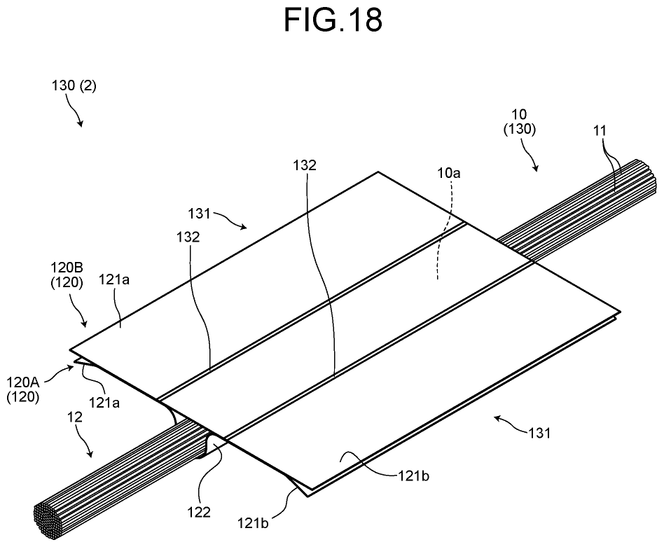

A wire harness 2 of the present modified example corresponds to the wire harness 1 of the embodiment described above in which the pair of exterior members 20 provided in the protection target region 10a (a part of the trunk line 12) is replaced with a pair of exterior members 120 described below (FIG. 18). The wire harness 2 of the present modified example is provided with a harness component 130 including the electric wire group 10 (the electric wire group 10 similar to that of the embodiment is used for convenience of description) and the pair of exterior members 120.

The pair of exterior members 120 is molded using an insulating raw material that enables welding between the exterior members 120 as in the exterior member 20 of the embodiment. Here, the pair of exterior members 120 is molded into a rectangular sheet shape.

In the pair of exterior members 120, the other exterior member 120 (hereinafter referred to as “other exterior member 120B”) is molded into a flat plate sheet shape using a material harder than that of one of the exterior members 120 (hereinafter referred to as “one exterior member 120A”) (FIG. 18). That is, the one exterior member 120A is molded using a material softer than that of the other exterior member 120B. The one exterior member 120A is molded in a flat sheet shape using such a soft material, and is deformed by applying pressure or heat thereto. As the flat sheet shape is deformed, the one exterior member 120A has a bent portion 122 between first end portion sides 121a in contact with each other with the protection target region 10a as a boundary and second end portion sides 121b in contact with each other with the protection target region 10a as a boundary in the pair of exterior members 120, the bent portion 122 forming a housing space of the protection target region 10a with respect to the other exterior member 120B having the flat plate sheet shape (FIG. 18). In the harness component 130, the first end portion sides 121a and the second end portion sides 121b are joint portions 131 coming into contact with each other between the pair of exterior members 120.

A manufacturing method of the wire harness 2 of the present modified example is basically the same as the manufacturing method of the wire harness 1 of the embodiment described above, but is different from the manufacturing method of the wire harness 1 of the embodiment in the following points.

First, in a first installation process of the present modified example, the one exterior member 120A having the flat sheet shape is placed on the first mold Ma provided with a trench Ma2 on the flat installation surface Ma1 (FIG. 19). Then, the manufacturing method of the present modified example includes a bent portion formation process of sandwiching the one exterior member 120A between the first mold Ma and a third mold Mc after the first installation process and fitting a protrusion Mc2 of the third mold Mc into the trench Ma2 of the first mold Ma to form the bent portion 122 in the one exterior member 120A along the trench Ma2 and the protrusion Mc2 (FIG. 19). Here, each of the trench Ma2 and the protrusion Mc2 is formed in a linear shape.

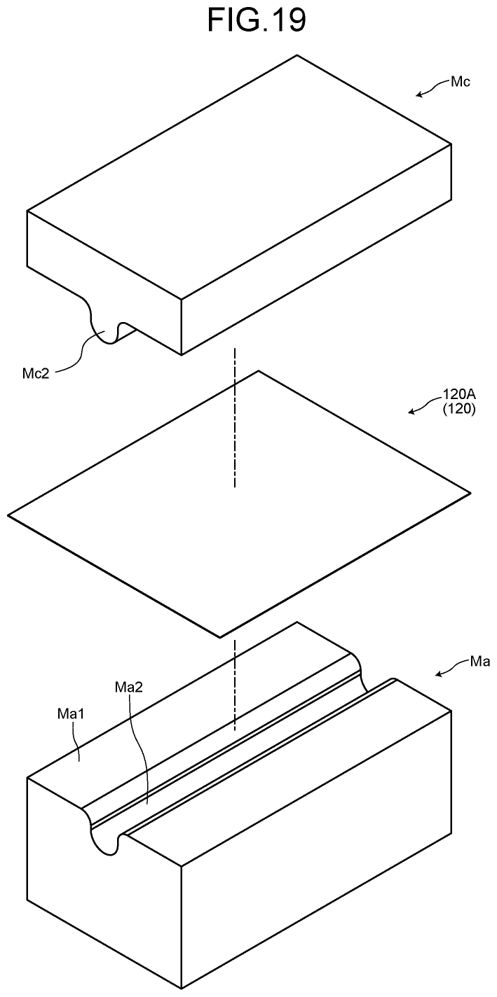

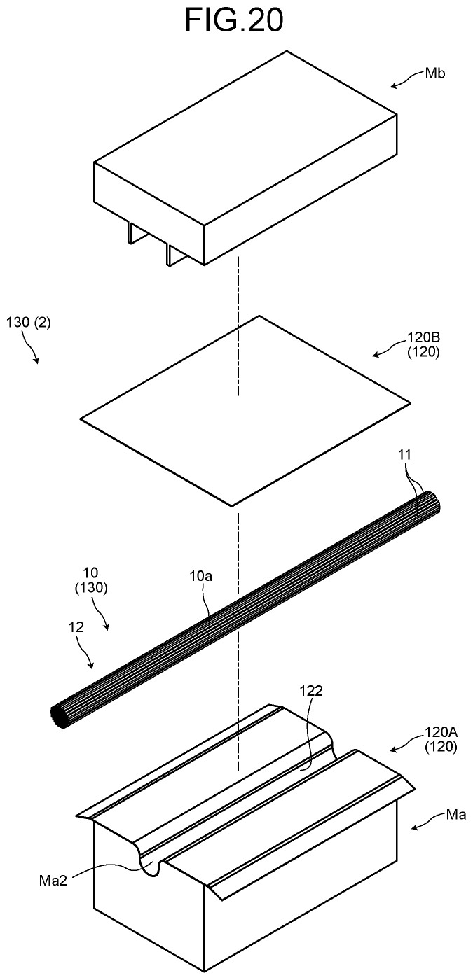

Next, in a second installation process of the present modified example, the protection target region 10a is installed in the bent portion 122 formed in the bent portion formation process (FIG. 20). Then, in a third installation process of the present modified example, the other exterior member 120B is placed on the one exterior member 120A, and the protection target region 10a in the bent portion 122 is sandwiched between the one exterior member 120A and the other exterior member 120B (FIG. 20). In a fourth installation process of the present modified example, the first end portion sides 121a in contact with each other with the protection target region 10a as the boundary and the second end portion sides 121b in contact with each other with the protection target region 10a as the boundary in the one exterior member 120A and the other exterior member 120B are sandwiched between the first mold Ma and the second mold Mb (FIG. 20).

Thereafter, the manufacturing method of the present modified example moves to a welding process as in the manufacturing method of the embodiment, and linear welds 132 (FIG. 18) are formed along the protection target region 10a (a part of the trunk line 12) on the first end portion sides 121a and the second end portion sides 121b.

The wire harness 2 of the present modified example described above obtains similar effects as the wire harness 1 of the embodiment. Then, in the wire harness 2 of the present modified example, it is sufficient to transport the pair of flat sheet-shaped exterior members 120 (the one exterior member 120A and the other exterior member 120B) to a work place, for example, by performing the above-described first installation process to welding process on one jig plate. Thus, in the wire harness 2 of the present modified example, the pair of exterior members 120 can be housed in a transport container or the like without a gap as compared with one using a tubular member such as a corrugated tube for an exterior member, and thus, transport cost required for the pair of exterior members 120 can be suppressed, and the cost can be reduced.

Further, in a case where the wire harness 2 of the present modified example is routed around another component such as an adjacent component in a vehicle, for example, a decrease in quality of the wire harness 2 can be suppressed by disposing the other exterior member 120B, which is harder, on the other component side.

Meanwhile, since a part of the trunk line 12 is the protection target region 10a in the present modified example, the trench Ma2 and the protrusion Mc2 having the linear shapes are provided in the first mold Ma and the third mold Mc, respectively. However, the wire harness 2 of the present modified example can also be applied, for example, when the protection target region 10a is the periphery of the branch portion 12a in the electric wire group 10. In this case, it is sufficient to form the trench Ma2 and the protrusion Mc2 along shapes of a part of the trunk line 12 including the branch portion 12a and the branch electric wire 13 in the first mold Ma and the third mold Mc, respectively, or to divide a part of the trunk line 12 including the branch portion 12a and the branch electric wire 13 into a plurality of areas and provide the first mold Ma and the third mold Mc respectively having the trench Ma2 and the protrusion Mc2 following shapes of the respective areas in the respective areas.

### Second Modified Example

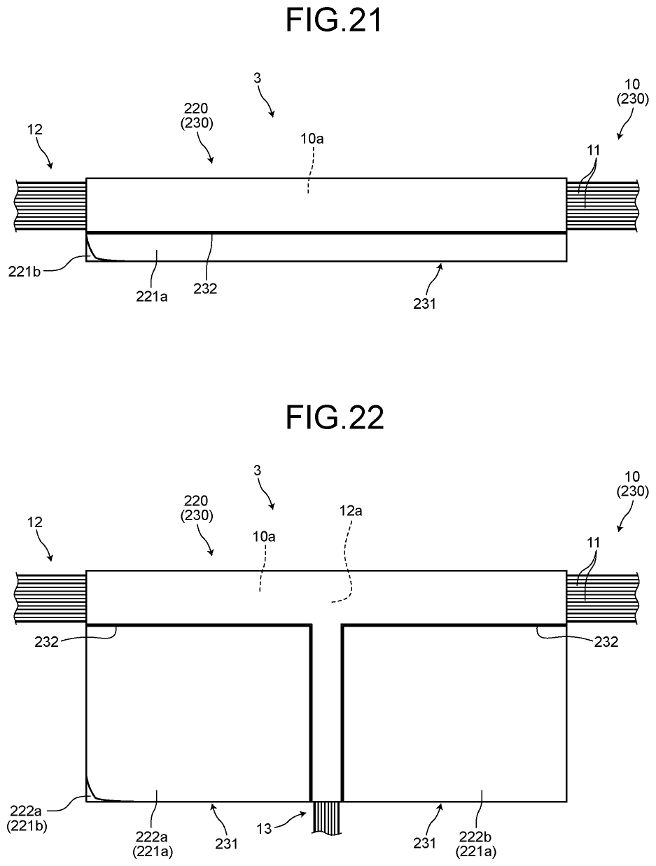

A wire harness 3 of the present modified example is provided with a harness component 230 including the electric wire group 10 (the electric wire group 10 similar to that of the embodiment is used for convenience of description) and a sheet-shaped insulating exterior member 220 that is folded and houses the protection target region 10a of the electric wire group 10 inside a fold (FIGS. 21 and 22). The harness component 230 includes joint portions 231 coming into contact with each other at tips of the fold of the exterior member 220 and a weld 232 having two free ends where the joint portions 231 are welded to each other along the axial direction of the protection target region 10a between the joint portions 231 in contact with each other (FIGS. 21 and 22).

In the harness component 230 illustrated here, as in the harness component 30 of the embodiment, a part of the trunk line 12 is set as the protection target region 10a, and the single exterior member 220 is attached to the part of the trunk line 12 (FIG. 21), and further, at a place different from the above protection target region 10a, a part of the trunk line 12 including the branch portion 12a and the branch electric wire 13 are set as the protection target region 10a, and the single exterior member 220 is attached to the periphery of the electric wire group 10 including the branch portion 12a (FIG. 22). In the harness component 230, the exterior member 220 is folded with the former protection target region 10a (a part of the trunk line 12) as an axis, end portions 221a and 221b coming in contact with each other at the tips of the fold are set as the joint portions 231, and the weld 232 is provided between the end portions 221a and 221b as the joint portions 231 (FIG. 21). Further, in the harness component 230, in the latter protection target region 10a, the exterior member 220 is folded with the trunk line 12 as an axis, and intermediate portions 222a and 222b located between the trunk line 12 and the branch electric wire 13 in each of the end portions 221a and 221b in contact with each other at the tips of the fold are set as the joint portions 231, and the welds 232 are respectively provided between the intermediate portions 222a and between the intermediate portions 222b as the joint portions 231 (FIG. 22). In the latter protection target region 10a, one branch electric wire 13 is branched from the branch portion 12a of the trunk line 12, and the intermediate portions 222a in contact with each other and the intermediate portions 222b in contact with each other are formed at two locations in the exterior member 220.

The exterior member 220 is molded using a weldable insulating raw material similar to that of the exterior member 20 of the embodiment. Here, the exterior member 220 having a rectangular sheet shape is used. Thus, in the former protection target region 10a (a part of the trunk line 12), the end portions 221a and 221b as the joint portions 231 are rectangular (FIG. 21). In the former protection target region 10a, the linear weld 232 extending in the axial direction of the protection target region 10a is formed between the end portions 221a and 221b as the joint portions 231. The weld 232 is disposed close to the protection target region 10a (a part of the trunk line 12). Further, in the latter protection target region 10a (the periphery of the electric wire group 10 including the branch portion 12a), the trunk line 12 and the branch electric wire 13 are orthogonal to each other, and thus, the intermediate portions 222a and 222b at the two locations, which are the joint portions 231 in the end portions 221a and 221b, are rectangular (FIG. 22). In the latter protection target region 10a, the L-shaped welds 232 each extending from the branch portion 12a in the axial direction of the trunk line 12 and the axial direction of the branch electric wire 13 are formed between the intermediate portions 222a and between the intermediate portions 222b, respectively. Each of the welds 232 is disposed close to the trunk line 12 and the branch electric wire 13.

The wire harness 3 is assembled by, for example, the following manufacturing method. Here, an example will be given regarding the former protection target region 10a (a part of the trunk line 12).

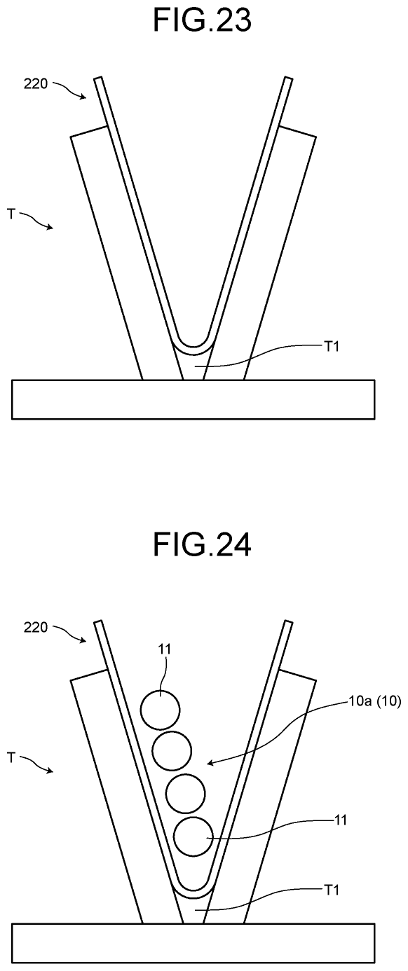

This manufacturing method includes a first installation process of placing the exterior member 220 in a V-shaped or U-shaped trench T1 of a jig T (FIG. 23). In the first installation process, the exterior member 220 is bent into a bent shape such as a V-shape or a U-shape along the shape of the trench T1 and placed in the trench T1. For example, the jig T is installed on a so-called jig plate or the like configured to assemble the wire harness 3.

This manufacturing method includes a second installation process of installing the protection target region 10a of the electric wire group 10 in the exterior member 220 having the bent shape (FIG. 24).

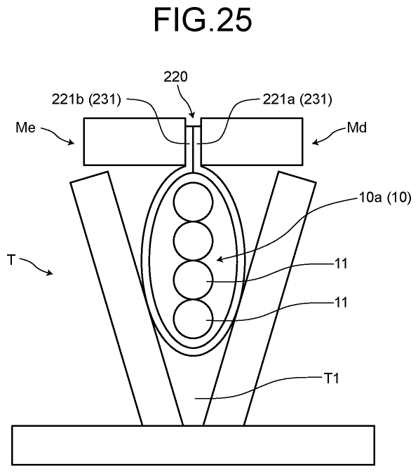

This manufacturing method includes a third installation process of sandwiching the end portions 221a and 221b at the tips of the fold with the protection target region 10a (a part of the trunk line 12) as the axis in the exterior member 220 between a first mold Md and a second mold Me (FIG. 25). Then, this manufacturing method includes a welding process of welding the end portions 221a and 221b of the exterior member 220 to each other along the axial direction of the protection target region 10a (FIG. 25). Here, the first mold Md and the second mold Me are electrodes, and predetermined locations of the end portions 221a and 221b are heated and welded. As a result, the linear weld 232 along the former protection target region 10a (a part of the trunk line 12) is formed at the end portions 221a and 221b.

As described above, in the wire harness 3 of the present modified example, the protection target region 10a of the electric wire group 10 is housed in the single folded exterior member 220, and the joint portions 231 in contact with each other at the tips of the fold are welded, whereby the protection target region 10a can be insulated and protected by the single exterior member 220. Thus, the wire harness 3 does not require an adhesive member or an adhesive tape to fix an exterior member as in a conventional wire harness, and only the single exterior member 220 is required, so that the cost can be reduced. Further, since the wire harness 3 does not require a work process of winding the adhesive tape, the cost can be reduced as in the wire harness 1 of the embodiment, and variations in quality of the exterior member 220 attached to the protection target region 10a can be suppressed as compared with the conventional wire harness.

Further, since the wire harness 3 of the present modified example wraps the protection target region 10a of the electric wire group 10 by folding the single exterior member 220, it is possible to cope with various lengths and various thicknesses of the electric wire group 10 only by changing a size of the exterior member 220.

Meanwhile, since the weld 232 is formed between the joint portions 231 in the single exterior member 220 to be close to the trunk line 12 and the branch electric wire 13 in the wire harness 3 of the present modified example, there is an excess portion that is not welded between the joint portions 231 as in the wire harness 1 of the embodiment. Thus, the excess portion in the harness component 230 of the present modified example may be cut off after welding as in the wire harness 1 of the embodiment. Further, the exterior member 220 molded into a form without the excess portion from the beginning may be used in the wire harness 3 of the present modified example.

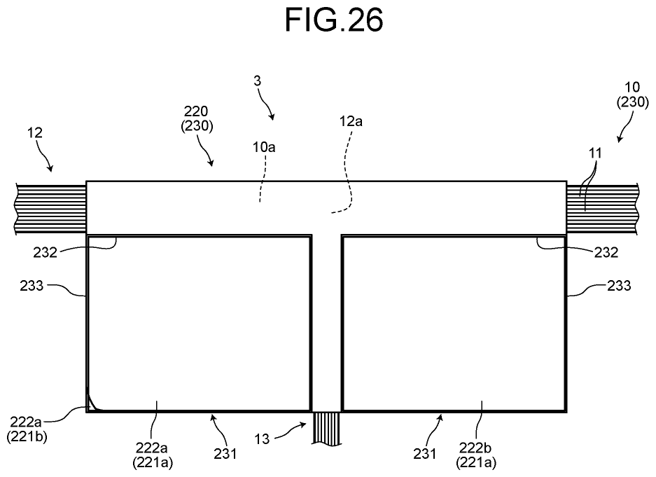

Furthermore, when a part of the trunk line 12 including the branch portion 12a and the branch electric wire 13 are set as the protection target region 10a in the wire harness 3 of the present modified example, there is a possibility that it is difficult to keep a shape between the trunk line 12 and the branch electric wire 13 constant because the branch electric wire 13 approaches the trunk line 12 or the like if cutting or the like is performed so that the excess portion (portion not welded between the end portions 221a and 221b of the exterior member 220) does not remain in the intermediate portions 222a and 222b as in the wire harness 1 of the embodiment. Therefore, it is desirable to provide the harness component 230 with auxiliary welds 233 each of is formed by welding the joint portions 231 between one free end and the other free end of the weld 232 between the joint portions 231 in contact with each other of the exterior member 220 so as to connect the one free end and the other free end (FIG. 26). For example, the auxiliary weld 233 is formed by welding outer peripheral edges of the joint portions 231 in contact with each other of the exterior members 220 to connect the one free end and the other free end of the weld 232. As a result, in the wire harness 3 of the present modified example, the joint portions 231 (the intermediate portions 222a and 222b) can be increased in rigidity and prevented from being deflected, and thus, the shape can be kept constant between the trunk line 12 and the branch electric wire 13 as in similar to the wire harness 1 of the embodiment

Here, the one free end and the other free end of the weld 232 are connected by the linear auxiliary weld 233 at each of the intermediate portions 222a and 222b of the exterior member 220. Further, the auxiliary weld 233 may be formed by welding the entire excess portions with respect to the linear welds 232.

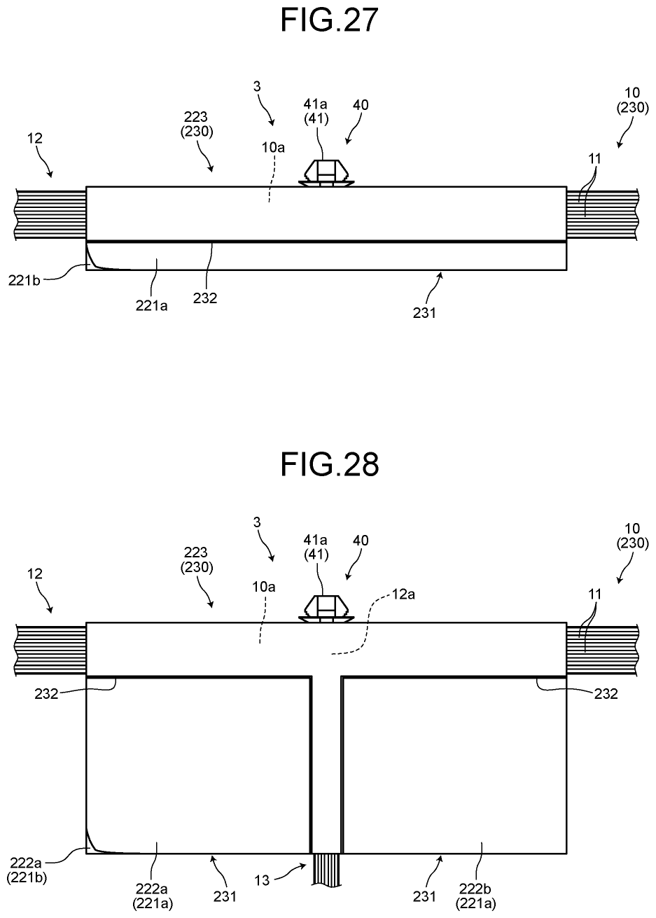

Here, the wire harness 3 of the present modified example may be provided with the clamp 40 as in the wire harness 1 of the embodiment (FIGS. 27 and 28). For example, the clamp 40 is fixed to the protection target region 10a of the electric wire group 10 by an exterior member 223 (FIGS. 27 and 28). The exterior member 223 is similar to the exterior member 23 of the embodiment, and has a through-hole (not illustrated) through which the clamp body 41 is inserted from a first wall surface side to a second wall surface side. In the wire harness 3 of the present modified example, the joint portions 231 in contact with each other of the exterior member 223 are welded to each other in a state where the clamp body 41 is inserted through the through-hole of the single exterior member 223, whereby the clamp 40 is fixed by the exterior member 223 and the protection target region 10a of the electric wire group 10.

In the harness component 230 of FIG. 27, a part of the trunk line 12 is set as the protection target region 10a, and the clamp 40 is fixed to the protection target region 10a by the exterior member 223.

Further, in the harness component 230 of FIG. 28, a part of the trunk line 12 including the branch portion 12a and the branch electric wire 13 are set as the protection target region 10a, and the clamp 40 is fixed to the protection target region 10a by the exterior member 223. In the harness component 230, the weld 232 of the intermediate portion 222a and the weld 232 of the intermediate portion 222b are brought close to the branch electric wire 13, and the branch electric wire 13 is sandwiched between the welds 232 at two locations, and the welds 232 at the two locations suppress relative displacement of the exterior member 223 with respect to the axial direction of the trunk line 12. Thus, relative displacement of the clamp 40 with respect to the axial direction of the trunk line 12 can be suppressed by the welds 232 at the two locations in the harness component 230. For example, in the exterior member 223 illustrated in FIG. 28, the clamp 40 is attached to the branch portion 12a by providing the through-hole in a place where the branch portion 12a is present.

Furthermore, the wire harness 3 of the present modified example may use a sheet-shaped exterior member having a shape other than a rectangle in accordance with a shape of the protection target region 10a as in the wire harness 1 of the embodiment.

Furthermore, in the wire harness 3 of the present modified example, the through-hole is formed in the vicinity of the branch portion 12a in the joint portion 231 of the exterior member 220 or 223, and a support pin of the support member S can be inserted into the through-hole when the exterior member 220 or 223 is assembled to the protection target region 10a as in the wire harness 1 of the embodiment.

### Third Modified Example

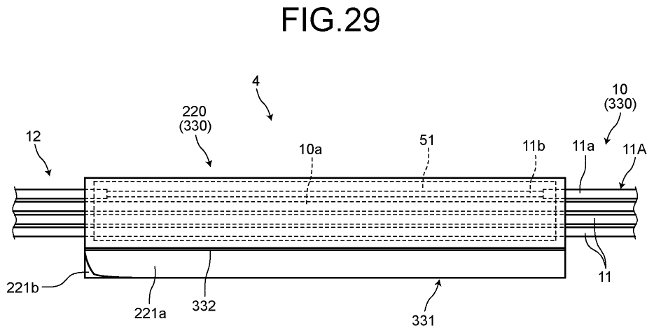

A wire harness 4 of the present modified example corresponds to the wire harness 3 of the second modified example described above in which a shield member 51 is interposed between the protection target region 10a of the electric wire group 10 and the exterior member 220 in order to obtain a protection function from noise (FIG. 29). Therefore, a harness component 330 of the present modified example is obtained by adding the shield member 51 to the harness component 230 of the second modified example. Incidentally, this drawing is simplified as compared with the explanatory view of the second modified example for convenience of illustration.

The shield member 51 used in the wire harness 4 is molded in a sheet shape. For example, here, a braid obtained by braiding element wires into a sheet shape or a metal foil such as an aluminum foil or a copper foil is used for the shield member 51. The shield member 51 covers the protection target region 10a of the electric wire group 10 over one circumference inside the folded exterior member 220. Further, the shield member 51 has a shape that does not enter a place where a weld 332 is formed between the end portions 221a and 221b so as not to interfere with welding between the end portions 221a and 221b, which are joint portions 331, of the exterior member 220 (FIG. 29).

Here, in the wire harness 4, one of the plurality of electric wires 11 constituting the electric wire group 10 is a drain wire 11A in which a sheath 11a is partially removed to expose a core 11b, and the exposed core 11b is brought into contact with the shield member 51 (FIG. 29).

The wire harness 4 is assembled by, for example, the following manufacturing method. A manufacturing method of the wire harness 4 of the present modified example is basically the same as the manufacturing method of the wire harness 3 of the second modified example described above, but is different from the manufacturing method of the wire harness 3 of the second modified example in the following points. In this example, a part of the trunk line 12 is set as the protection target region 10a.

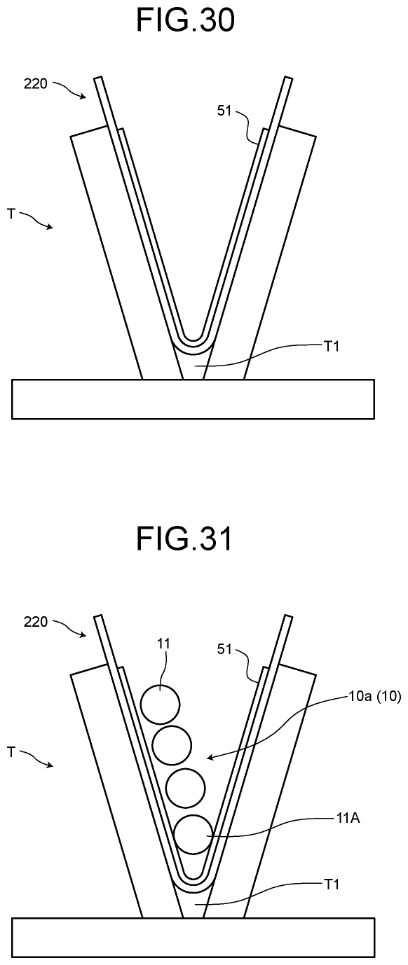

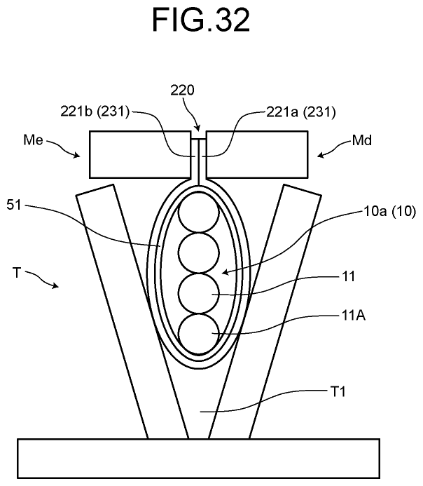

The manufacturing method of the present modified example includes a shield installation process (FIG. 30) of bending and placing the sheet-shaped shield member 51 into a bent shape such as a V-shape or a U-shape along an inner wall surface of the exterior member 220 having a bent shape after a first installation process (FIG. 23). Then, in the present modified example, in a second installation process as a subsequent process of the shield installation process, the protection target region 10a is installed in the shield member 51 having the bent shape with the drain wire 11A at a tip, and the exposed core of the drain wire 11A is brought into contact with an inner wall surface of the shield member 51 (FIG. 31). For example, in the second installation process, first, a portion of the drain wire 11A corresponding to the protection target region 10a is inserted into the bent-shaped shield member 51. Thereafter, each one, a plurality, or a bundle of portions of the remaining electric wires 11 corresponding to the protection target region 10a is inserted into the bent-shaped shield member 51. In the manufacturing method of the present modified example, the above-described third installation process and welding process are then performed (FIG. 32).

The wire harness 4 of the present modified example described above obtains similar effects as the wire harness 3 of the second modified example. Further, a conventional wire harness may include one drain wire for each of a plurality of electric wire bundles. However, the wire harness 4 of the present modified example can cause only one drain wire 11A to remain and be collected in one electric wire group 10 from among the electric wires 11 of the plurality of electric wire bundles of the conventional wire harness, and thus, the cost can be reduced also in this respect.

Here, in the wire harness 4 of the present modified example, the exterior member 220 and the shield member 51 may be provided for each bundle of one drain wire 11A collected for each circuit and the remaining electric wires 11 in a case where the drain wire 11A is required for each circuit.

Further, in the wire harness 4 of the present modified example, the exterior member 220 and the shield member 51 can be provided at a place other than a place defined as the protection target region 10a in the electric wire group 10. That is, in the wire harness 4, the exterior member 220 can also be used as a member that fixes the shield member 51 to the electric wire group 10. Thus, in the wire harness 4 of the present modified example, the shield member 51 can be retrofitted to a place where a shield function is required after the assembly is completed. Incidentally, in this case, the main function of the exterior member 220 is to a function that fixes the shield member 51 to the electric wire group 10, but also secondarily protects the place of the electric wire group 10 provided with the shield member 51. Therefore, the place of the electric wire group 10 becomes the protection target region 10a as a result.

### Fourth Modified Example

A wire harness 5 of the present modified example is provided with a plurality of harness components each of which includes an electric wire group including a plurality of electric wires and a sheet-shaped insulating exterior member housing a protection target region of the electric wire group inside. In the wire harness 5, the plurality of harness components are integrated as one component by welding the exterior members of the plurality of harness components to each other. In other words, the wire harness 5 is obtained by dividing the electric wire groups into a plurality of circuits to manufacture the harness components for the circuits, respectively, and integrating the harness components for the respective circuits as one component at a place where the exterior members are located. For example, the wire harness 5 of the present modified example includes a plurality of (at least two or more) harness components selected from among the harness component 30 of the embodiment, the harness component 130 of the first modified example, the harness component 230 of the second modified example, and the harness component 330 of the third modified example.

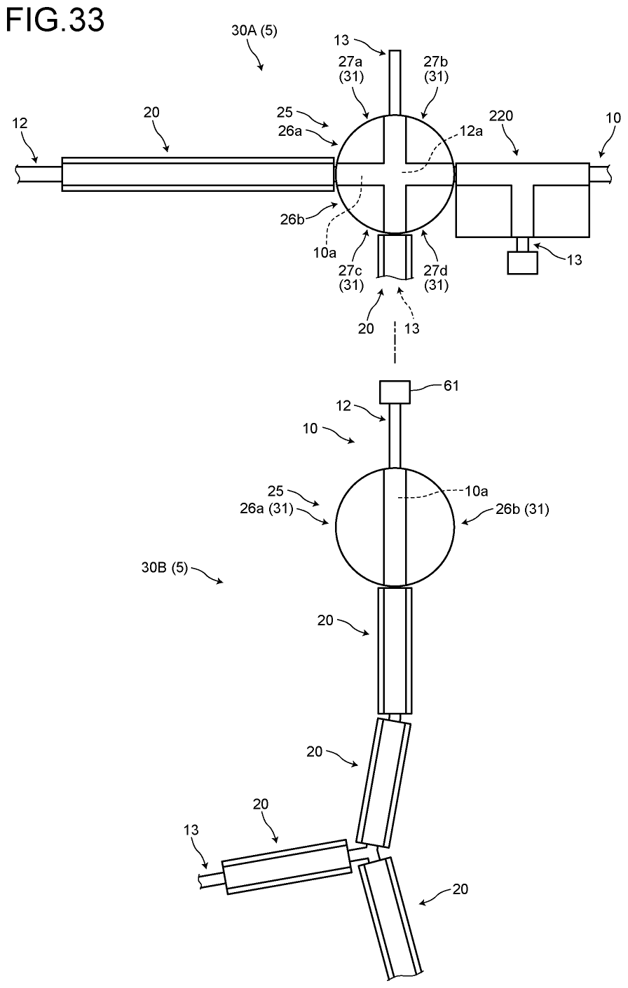

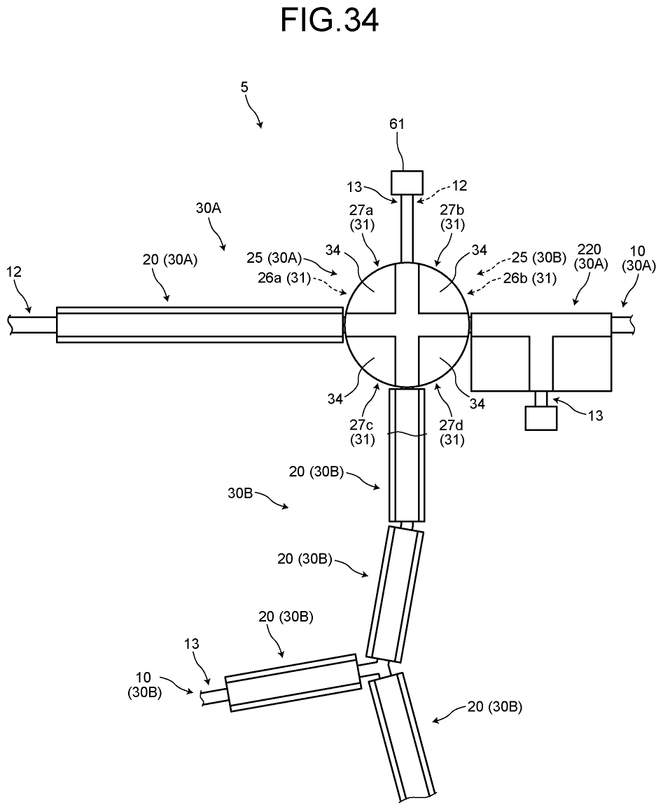

The wire harness 5 of the present modified example exemplified hereinafter includes a plurality of the harness components 30 of the embodiment, and the plurality of harness components 30 are integrated (FIGS. 33 and 34). In the wire harness 5, the plurality of harness components 30 are integrated as one component by welding the respective joint portions 31 of the plurality of harness components 30 to each other. Thus, in the wire harness 5, the above-described excess portion 31a is left in the joint portion 31 in each of the harness components 30, and the excess portions 31a are welded to each other. Incidentally, the exterior member 220 of the modified example is also present in the drawing, but is referred to as the harness component 30 of the embodiment for convenience.

In the wire harness 5, all of the plurality of harness components 30 are integrated by welding the joint portions 31 between the pair of exterior members 20 in the case of including the pair of exterior members 20. Further, all of the plurality of harness components 30 are integrated by welding the joint portions 31 between the pair of exterior members 25 in the case of including the pair of exterior members 25. Further, in a case where one of the plurality of harness components 30 is provided with the clamp 40 and includes a pair of the exterior member 20 and the exterior member 23, the plurality of harness components 30 are integrated by welding the joint portions 31 between the pair of exterior members (the exterior member 20 and the exterior member 23) and the pair of exterior members 20 or the pair of exterior members 25 of the other harness component 30.

The wire harness 5 exemplified here includes two harness components 30 (a harness component 30A on one side and a harness component 30B on the other side) in which the protection target region 10a of the electric wire group 10 is covered with the pair of exterior members 25 (FIGS. 33 and 34).

In the harness component 30A on one side, the electric wire group 10 has two branch electric wires 13 branching from the branch portion 12a of the trunk line 12, and a part of the trunk line 12 including the branch portion 12a and the branch electric wires 13 are set as the protection target region 10a covered by the pair of exterior members 25 (FIG. 33). Therefore, the intermediate portions 27a, 27b, 27c, and 27d at four locations are provided as the joint portions 31 in the pair of exterior members 25 of the harness component 30A on one side.

Further, in the harness component 30B on the other side, a part of the trunk line 12 is set as the protection target region 10a covered by the pair of exterior members 25 (FIG. 33). Therefore, the first end portion sides 26a in contact with each other and the second end portion sides 26b in contact with each other with the protection target region 10a (a part of the trunk line 12) as a boundary are provided as the joint portions 31 in the pair of exterior members 25 of the harness component 30B on the other side.

In the wire harness 5 of this example, the intermediate portions 27a and 27c of the pair of exterior members 25 of the harness component 30A on one side are welded to the first end portion sides 26a of the pair of exterior members 25 of the harness component 30B on the other side, and the intermediate portions 27b and 27d of the pair of exterior members 25 of the harness component 30A on one side are welded to the second end portion sides 26b of the pair of exterior members 25 of the harness component 30B on the other side. Therefore, the welds 34 at four locations respectively corresponding to the intermediate portions 27a, 27b, 27c, and 27d are formed in the wire harness 5 (FIG. 34).

Here, in the wire harness 5 of this example, one of the branch electric wires 13 of the harness component 30A on one side and the trunk line 12 of the harness component 30B on the other side are connector-connected to a common mating connector. Thus, in the wire harness 5, a connector 61 may be attached to one terminal of the one branch electric wire 13 of the harness component 30A on one side and the trunk line 12 of the harness component 30B on the other side, and the other terminal may be connected to the connector 61, for example, after the joint portions 31 of the harness components 30A on both sides are welded to each other (FIGS. 33 and 34). Here, the connector 61 is attached in advance to a terminal of the trunk line 12 of the harness component 30B on the other side, and a terminal of the one branch electric wire 13 in the harness component 30A on one side is connected to the connector 61 after the joint portions 31 of the harness components 30 on both sides are welded to each other.

In a case where the wire harness 5 of the present modified example includes a plurality of the harness components 130 of the first modified example, the excess portions of the joint portions 131 of the respective harness components 130 are welded to each other (not illustrated) as in the case of including the plurality of harness components 30 of the embodiment. Incidentally, the harness component 130 of the first modified example can be classified as one obtained by changing hardness of each of the pair of exterior members 20 in the harness component 30 of the embodiment. Thus, hereinafter, the harness component 130 of the first modified example is treated as the same as the harness component 30 of the embodiment.

Further, in a case where the wire harness 5 of the present modified example includes a plurality of the harness components 230 of the second modified example, the excess portions of the joint portions 231 of the respective harness components 230 are welded to each other (not illustrated) as in the case of including the plurality of harness components 30 of the embodiment. In the wire harness 5, the plurality of harness components 230 are integrated by welding the joint portions 231 between the exterior members 220 in the case of including the exterior member 220. Further, in a case where one of the plurality of harness components 230 is provided with the clamp 40 and includes the exterior member 223, the plurality of harness components 230 are integrated by welding the joint portions 31 between the exterior member 223 provided with the clamp 40 and the exterior member 220 of the other harness component 30.

In a case where the wire harness 5 of the present modified example includes a plurality of the harness components 330 of the third modified example as in a case where the drain wire 11A is required for each circuit, the excess portions of the joint portions 331 of the harness components 330 are welded to each other (not illustrated) as in the case of including the plurality of harness components 230 of the second modified example. Incidentally, the harness component 330 of the third modified example can be classified as one obtained by adding the shield member 51 to the harness component 230 of the second modified example. Thus, hereinafter, the harness component 330 of the third modified example is treated as the same as the harness component 230 of the second modified example.

Further, the wire harness 5 of the present modified example can be configured such that at least one harness component 30 of the embodiment (the harness component 130 of the first modified example) and at least one harness component 230 of the second modified example (the harness component 330 of the third modified example) are provided as harness components, and the plurality of harness components are integrated by welding joint portions between the respective exterior members (not illustrated). Hereinafter, for convenience of description, the harness component 30 of the embodiment is referred to as a “first harness component 30”, and the harness component 230 of the second modified example is referred to as a “second harness component 230”. Then, in the first harness component 30, the electric wire group 10 is referred to as a “first electric wire group 10”, and the exterior members 20, 23, and 25 enclosing the first electric wire group 10 are collectively referred to as a “first exterior member”. Further, in the second harness component 230, the electric wire group 10 is referred to as a “second electric wire group 10”, and the exterior members 220 and 223 enclosing the second electric wire group 10 are collectively referred to as a “second exterior member”. For example, in a case where the wire harness 5 includes one first harness component 30 and one second harness component 230, integration is performed by welding the excess portions of the joint portions 31 between the first exterior member of the first harness component 30 and the second exterior member of the second harness component 230.

The wire harness 5 of the present modified example described above similarly obtains effects exhibited by harness components to be combined. Further, in the wire harness 5 of the present modified example, the harness components for the respective circuits are manufactured, and the harness components for the respective circuits are integrated as one component at the place where the exterior members are located, so that the workability of assembly is excellent, and the cost can be reduced also in this respect. Further, in the wire harness 5 of the present modified example, it is possible to prepare a plurality of harness components for circuits, respectively, and appropriately select and combine some of the plurality of harness components, so that the cost can be reduced also in this respect. Further, the wire harness 5 of the present modified example can also be obtained by appropriately selecting and combining some of the plurality of harness components, and different specifications of the combinations can be easily coped with, so that the cost can be reduced also in this respect. Further, in the wire harness 5 of the present modified example, it is possible to set a harness component for each circuit in advance as a standard product and appropriately select and combine some of a plurality of the harness components, so that the number of components to be newly generated can be reduced, and the cost can be reduced also in this respect. Further, in the wire harness 5 of the present modified example, the positional accuracy of each of the components when being integrated can be easily increased by enhancing the positional accuracy of the exterior member with respect to the protection target region 10a for each of the harness components, so that the cost can be reduced also in this respect.

Here, the wire harness 5 of the present modified example does not require a dedicated fixing component to fix the respective harness components to each other, so that the cost can be reduced also in this respect. Further, in the wire harness 5 of the present modified example, in a case where it is necessary to add a circuit after the assembly and there is no exterior member for assembling a harness component for a retrofitted circuit to the originally existing electric wire group 10, it is possible to weld an exterior member of a harness component for a retrofitted circuit to an exterior member only by providing the exterior member at a desired place of the originally existing electric wire group 10. Thus, in the wire harness 5 of the present modification, it is easy to retrofit the circuit without using a dedicated fixing component, and the cost can be reduced also in this respect.

The wire harness according to the present embodiment and a wire harness created by the manufacturing method according to the present embodiment do not require an adhesive member or an adhesive tape to fix an exterior member as in the conventional wire harness, and thus, cost reduction can be achieved. Further, the wire harness does not require a work process of winding the adhesive tape, and thus, cost reduction can be achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a harness component that includes an electric wire group including a plurality of electric wires, and a pair of sheet-shaped insulating exterior members sandwiching a protection target region of the electric wire group and housing the protection target region inside, wherein
the harness component includes joint portions in contact with each other between the pair of exterior members, and a weld having two free ends where the joint portions are welded to each other along an axial direction of the protection target region between the joint portions in contact with each other.

2. The wire harness according to claim 1, wherein
a plurality of the harness components are provided, and
the plurality of harness components are integrated by welding the joint portions to each other between the pairs of exterior members of the plurality of harness components.

3. A wire harness comprising:
a harness component that includes an electric wire group including a plurality of electric wires, and a sheet-shaped insulating exterior member that is folded and houses a protection target region of the electric wire group inside a fold, wherein
the harness component includes joint portions in contact with each other at tips of the fold of the exterior member, and a weld having two free ends where the joint portions are welded to each other along an axial direction of the protection target region between the joint portions in contact with each other.

4. The wire harness according to claim 3, wherein
a plurality of the harness components are provided, and
the plurality of harness components are integrated by welding the joint portions to each other between the exterior members of the plurality of harness components.

5. A wire harness comprising:
a plurality of harness components each of which includes an electric wire group including a plurality of electric wires and a sheet-shaped insulating exterior member housing a protection target region of the electric wire group inside, wherein
at least one first harness component and at least one second harness component are provided as the harness components, the first harness component including a first electric wire group as the electric wire group and a pair of first exterior members that sandwich and house a protection target region of the first electric wire group inside and serve as the exterior member, the second harness component including a second electric wire group as the electric wire group and a second exterior member that is folded, houses a protection target region of the second electric wire group inside a fold, and serves as the exterior member,
the first harness component includes joint portions in contact with each other between the pair of the first exterior members, and a weld having two free ends where the joint portions are welded to each other along an axial direction of the protection target region of the first electric wire group between the joint portions in contact with each other,
the second harness component includes joint portions in contact with each other at tips of the fold of the second exterior member, and a weld having two free ends where the joint portions are welded to each other along an axial direction of the protection target region of the second electric wire group between the joint portions in contact with each other, and
the plurality of harness components are integrated by welding the joint portions between the exterior members of the plurality of harness components.

6. The wire harness according to claim 1, wherein
the electric wire group includes a trunk line and a branch electric wire branching from a branch portion of the trunk line, and a part of the trunk line including the branch portion and the branch electric wire are set as the protection target region.

7. The wire harness according to claim 2, wherein
the electric wire group includes a trunk line and a branch electric wire branching from a branch portion of the trunk line, and a part of the trunk line including the branch portion and the branch electric wire are set as the protection target region.

8. The wire harness according to claim 3, wherein
the electric wire group includes a trunk line and a branch electric wire branching from a branch portion of the trunk line, and a part of the trunk line including the branch portion and the branch electric wire are set as the protection target region.

9. The wire harness according to claim 4, wherein
the electric wire group includes a trunk line and a branch electric wire branching from a branch portion of the trunk line, and a part of the trunk line including the branch portion and the branch electric wire are set as the protection target region.

10. The wire harness according to claim 5, wherein
the electric wire group includes a trunk line and a branch electric wire branching from a branch portion of the trunk line, and a part of the trunk line including the branch portion and the branch electric wire are set as the protection target region.

11. The wire harness according to claim 6, wherein
the harness component is provided with an auxiliary weld formed by welding the joint portions between one of the free ends and the other free end of the weld between the joint portions in contact with each other to connect the one free end and the other free end.

12. The wire harness according to claim 11, wherein
the auxiliary weld is obtained by welding outer peripheral edges of the joint portions in contact with each other to connect the one free end and the other free end of the weld.

13. The wire harness according to claim 1, wherein
in the harness component, first end portion sides in contact with each other with the protection target region as a boundary and second end portion sides in contact with each other with the protection target region as a boundary in the pair of exterior members are set as the joint portions,
one exterior member of the pair of exterior members is formed in a flat plate sheet shape using a material harder than a material of the other exterior member, and
the other exterior member has, between the first end portion side and the second end portion side, a bent portion that forms a housing space of the protection target region with respect to the one exterior member.

14. The wire harness according to claim 1, further comprising:
a clamp that includes a clamp body configured to assemble a predetermined location of the electric wire group to an object to be assembled, and a fixing protrusion protruding from the clamp body, wherein
the exterior member has a through-hole through which the clamp body is inserted from a first wall surface side to a second wall surface side, and sandwiches the fixing protrusion between the first wall surface and the electric wire group.

15. The wire harness according to claim 14, wherein
the electric wire group includes a trunk line and a branch electric wire branching from a branch portion of the trunk line, and a part of the trunk line including the branch portion and the branch electric wire are set as the protection target region, and
the exterior member includes the through-hole at a place where the branch portion is present.

16. The wire harness according to claim 1, further comprising:
a sheet-shaped shield member interposed between the protection target region and the exterior member, wherein
one of the plurality of electric wires constituting the electric wire group is a drain wire in which a sheath is partially removed to expose a core and the exposed core is brought into contact with the shield member.

17. A manufacturing method of a wire harness, comprising:
a first installation process of placing one sheet-shaped insulating exterior member on an installation surface of a first mold;
a second installation process of placing a protection target region of an electric wire group including a plurality of electric wires on the one exterior member;
a third installation process of placing another sheet-shaped insulating exterior member on the one exterior member and the protection target region and sandwiching the protection target region between the one exterior member and the another exterior member;
a fourth installation process of sandwiching first end portion sides and second end portion sides, viewed from the protection target region, in the one exterior member and the another exterior member between the first mold and a second mold; and
a welding process of welding the first end portion sides and the second end portion sides in the one exterior member and the another exterior member along an axial direction of the protection target region.

18. The manufacturing method of a wire harness according to claim 17, wherein,
in the first installation process, the one exterior member having a flat sheet shape is placed on the first mold having a trench provided on the installation surface,
the manufacturing method further includes
a bent portion formation process of sandwiching the one exterior member between the first mold and a third mold after the first installation process and fitting a protrusion of the third mold into the trench of the first mold to form a bent portion along the trench and the protrusion in the one exterior member,
in the second installation process, the protection target region is installed in the bent portion formed in the bent portion formation process,
in the third installation process, the another exterior member molded in a flat plate sheet shape using a material harder than a material of the one exterior member is placed on the one exterior member, and the protection target region in the bent portion is sandwiched between the one exterior member and the another exterior member, and
in the fourth installation process, the first end portion sides in contact with each other with the protection target region as a boundary and the second end portion sides in contact with each other with the protection target region as a boundary in the one exterior member and the another exterior member are sandwiched between the first mold and the second mold.

19. A manufacturing method of a wire harness, comprising:
a first installation process of bending and placing a sheet-shaped insulating exterior member into a V-shaped or U-shaped bent shape along a shape of a V-shape or U-shaped trench in the trench provided in a jig;
a second installation process of installing a protection target region of an electric wire group including a plurality of electric wires in the exterior member having the bent shape;
a third installation process of sandwiching end portions at tips of a fold with the protection target region as an axis in the exterior member between a first mold and a second mold; and
a welding process of welding the end portions of the exterior member to each other along an axial direction of the protection target region.

20. The manufacturing method of a wire harness according to claim 19, further comprising:
a shield installation process of bending and placing a sheet-shaped shield member into a V-shaped or U-shaped bent shape along an inner wall surface of the exterior member having the bent shape after the first installation process, wherein,
in the second installation process, the protection target region is installed in the shield member having the bent shape with a drain wire at a tip, and an exposed core of the drain wire is brought into contact with an inner wall surface of the shield member.
